(19) United States
(12) Patent Application Publication
(10) Pub. No.: US 2024/0017293 A1
(43) Pub. Date: Jan. 18, 2024

(54) Acoustic Transponder, Use of an Acoustic Transponder, Method for Producing a Transponder, and Acoustic Transmission System

(71) Applicant: TDK Electronics AG, München (DE)

(72) Inventor: Michael Gebhart, Linz (AT)

(21) Appl. No.: 18/252,788

(22) PCT Filed: Nov. 9, 2021
(86) PCT No.: PCT/EP2021/081139

§ 371 Date: May 12, 2023

(30) Foreign Application Priority Data
Nov. 16, 2020 (DE) 102020130172.3

(51) Int. Cl. B06B 1/06; G01S 15/74; H04B 11/00

(52) U.S. Cl. CPC B06B 1/0644; G01S 15/74; H04B 11/00

(57) ABSTRACT

An acoustic transponder (1) for an acoustic transmission system is described, comprising a transponder chip (2) and a piezoelectric element (4) for converting a carrier frequency into an electric voltage, the transponder (1) having a miniaturized design. Furthermore, a method for manufacturing a miniaturized transponder, the use of a miniaturized transponder, and an acoustic transmission system comprising the miniaturized transponder are described.

The present invention relates to an acoustic transponder for transmitting information by means of an acoustic wave. The invention further relates to the use of an acoustic transponder and a method for manufacturing an acoustic transponder. The present invention further relates to the associated transmission system using acoustic waves.

There are requirements to identify metal tooling, especially in automated manufacturing processes. This can be used to know the manufacturer, date of manufacture, time in use, usable life or any maintenance that may be required (grinding, retooling, etc.) for the individual tool, and of course also enable assignment to a manufacturer, a specific batch or the like in the event of defects. Especially for new manufacturing processes in the field of additive processes (printing of metal parts), identification is also an essential issue, for example when assembling several printed parts.

The workpiece itself can use RFID (Radio-Frequency Identification—identification by means of electromagnetic waves) to indicate to an Industry 4.0 manufacturing plant which processes are to be applied and in what order.

If the surface of the workpiece is changed by machining, means of identification attached to the surface are a hindrance. In addition to identification, the measurement and transmission of properties from inside the tool or printed part can also be essential, such as temperature, mechanical forces or vibrations.

A special topic is the analysis of the internal structure, the homogeneity, of a corresponding tool or printed part. This can be measured by acoustic wave reflected from manufacturing defects. The embedding of such a miniaturized measuring system, to which necessary operating power is transmitted and a bidirectional communication exists, is also a possible use case for the technology described herein.

There are several identification technologies that can be used in principle. These include optical barcodes or 2D codes, which can also be printed in relief on the surface, radio-based RFID processes, or even well-documented handling of a tool.

These methods known today all have their disadvantages. It is difficult to attach antennas for radio-based processes directly to metal, embedding them completely in metal is not physically feasible for the application, since electric and magnetic fields are practically completely absorbed by the metal (Faraday cage). The use of ferrites for shielding, the use of so-called glass transponders that can be embedded in a blind hole in the tool, is technically possible, but expensive and prone to further problems, such as mechanical forces that will be present specifically in the tool.

Some references for companies with RFID products dedicated to this topic are:
https://www.balluff.com/en/de/industries-and-solutions/solutions-and-technologies/tool-id/
https://www.turck.de/en/tool-identification-480.php
https://www.harting.com/UK/en-gb/markets/automatic-tool-identification
https://rfid-europe.com/product/anlagen-und-logistik-tag-confidex-ironside-micro/https://www.nfcweb
https://www.nfcwebshop.at/glass-tag-sokymat-hf-high-frequency-transponder.html
https://www.zoller.info/at/produkte/toolmanagement/datentransfer/zidcode?r=1
https://www.iis.fraunhofer.de/de/ff/lv/net/projekte/rfid_metal1.html
https://www.harting.com/DE/de/rfid
https://www.innovating-automation.blog/tool-identification-in-metalworking-2/

Alternative ID technologies, such as inscriptions, stickers, optical codes also in relief, are also located on the surface of the tool, where they are also exposed to the risk of being abraded, soiled and illegible.

The object of the present invention is to describe an acoustic transponder, the use of an acoustic transponder, a method for manufacturing an acoustic transponder, and an acoustic transmission system which solve the above problems.

This task is solved by an acoustic transponder, the use of a miniaturized transponder, a method for manufacturing a miniaturized transponder and an acoustic transmission system according to the independent claims.

According to one aspect, an acoustic transponder is described. The acoustic transponder is adapted to enable an information transmission by means of an acoustic wave. The acoustic transponder is adapted for integration into an acoustic transmission system. The acoustic transponder is characterized by the fact that an information processing, such as in the sense of receiving a command and a response with an identification number, is generated entirely in a silicon chip, and not by surface acoustic wave (SAW) transponder reflectors.

The acoustic transponder is adapted to identify an object (for example a metallic component and/or a 3D printed part), to control an object and/or to take measurements in an interior of the object. The acoustic transponder is adapted to acquire measurement data, for example from a surface (inner surface or outer surface) of the object and/or from an interior of the object. The acoustic transponder is adapted to create a communication channel for transmitting information and energy by means of a material wave, in particular through a metal surface. The acoustic transponder is adapted for use in an extended temperature range, preferably from −40° C. to +105° C.

The acoustic transponder has at least one, preferably exactly one, transponder chip. The transponder chip is a silicon chip. The transponder chip has an integrated circuit (IC). The IC is preferably of the “bare die” design (i.e., without a housing).

The acoustic transponder further comprises a piezoelectric element. The piezoelectric element is adapted and arranged to convert an electrical voltage signal, such as a carrier frequency, into an acoustic wave of the same signal form. The piezoelectric element is an electroacoustic transducer. The piezoelectric element serves as a substrate of the acoustic transponder. Preferably, the piezoelectric element comprises lead-free material. Particularly preferably, the piezoelectric element is made of lead-free material. This makes the acoustic transponder RoHS-compliant (RoHS stands for “Restriction of (the use of certain) Hazardous Substances in electrical and electronic Equipment”). Alternatively, the piezoelectric element can comprise PZT (lead zirconate titanate).

The piezoelectric element is formed in a disk shape. In particular, a height or layer thickness of the piezoelectric element is less than a width or diameter of the piezoelectric element. Alternatively, however, the piezoelectric element may be rectangular in shape. This is particularly convenient if the transponder is to be coupled to a curved surface, such as a pipe wall. The acoustic transponder can be correspondingly disk-shaped (cylindrical) or rectangular. The piezoelectric element exhibits resonances due to its geometry and material properties.

The acoustic transponder has a miniaturized design. In other words, the acoustic transponder has a low overall height and/or a small volume. In particular, the acoustic transponder exhibits a smaller or more compact design than conventional transponders for an acoustic transmission system. For example, the transponder has a height of <3 mm, for example ≤1 mm or ≤500 μm. The piezoelectric element has a height≤300 μm, preferably ≤200 μm.

Due to the miniaturized design, the acoustic transponder can be used extremely flexibly and can be embedded, for example completely, in an object. As an alternative to integration into an object, the transponder can be adapted particularly easily to a surface of an object, for example to an outer surface or to an inner surface. The acoustic transponder can also be adapted particularly well to the properties of existing systems, for example contactless cards or NFC (near field communication) technology.

Information to be transmitted, which is stored in the mechanical vibration is not exposed to the same interference at the transmission channel from electromagnetic fields of neighboring systems as is the case when radio-based methods are used. The acoustic identification method using the acoustic transponder can therefore also be used in the presence of strong electromagnetic fields.

Furthermore, the same approval procedures and the associated effort and costs for the use or marketing of the acoustic transponder are not necessary, since the transponder is based on the use of an acoustic wave, and not an electromagnetic wave.

According to one embodiment, the transponder is adapted to be completely embedded in an object or workpiece. The workpiece can be a (preferably metallic) component and/or a 3D printed part. The workpiece can be a metal tool.

The miniaturized design allows the transponder to be completely embedded in the workpiece. In particular, the surface of the workpiece can be completely closed to carry the acoustic transponder inside for identification. The entire surface of the workpiece can thus be processed without affecting the identification of the workpiece.

The low height and small volume of the acoustic transponder only lead to a slight or negligible weakening of the workpiece (e.g. made of metal) in which the transponder is embedded. Furthermore, it is possible to embed the transponder even in small pieces of metal. Due to the compact design of the transponder, no surface structure is created by its embedding and/or no hole is left in the metal as is the case, for example, with glass transponders. In particular, there is no externally visible defect, and there is also no externally easily recognizable identification of the tagged object.

According to one embodiment, the transponder is adapted to be acoustically connected to a surface of a workpiece. The workpiece or object preferably comprises metal. The workpiece can comprise a metal plate or a metal tube. The transponder can be detachably (e.g., magnetically) or non-detachably (e.g., by means of a thin adhesive layer) attached to the metal surface. The transponder may be attached to an inner surface or to an outer surface of the workpiece.

To achieve good acoustic contact between the transponder and the acoustic channel, i.e. the metallic surface of the workpiece, a coating with a thin elastic layer can be provided on the bottom side of the transponder. In this context, the bottom side of the transponder means that outer surface of the transponder that faces the workpiece in the installed state.

The purpose of the coating is to fill the cavities that form due to the surface roughness of the opposing metal surfaces (metallic surface of the workpiece and (metallic) bottom side of the transponder) to a large extent with a medium that has significantly higher acoustic impedance than air. The efficiency of the acoustic coupling can thus be significantly increased.

According to one embodiment, the transponder chip is applied to the piezoelectric element using flip-chip technology.

The “direct chip attach” or “flip chip” technology for the connection between the transponder chip and the piezoelectric element has the effect that the design of the transponder can be kept extremely compact. For example, one area of the transponder can correspond to the area of the bare die of the integrated circuit/transponder chip.

With a usual chip structure size of 180 nm and depending on memory size and performance, a corresponding silicon die has an area of approximately 0.4-4 mm² and a maximum thickness of approximately 170 μm. The transponder chip can also be designed with so-called connection elements (e.g., bumps), which form an elevation on a surface and represent a contact connection to the piezoelectric element.

Altogether, the total height is very low, for example about 500 μm (about 170 μm height of the transponder chip as bare die+about 300 μm height of the piezoelectric element as PCB (printed circuit board)+height of a protective cover or surface passivation).

According to one embodiment, a printed circuit board is arranged between the transponder chip and the piezoelectric element. The circuit board establishes an electrical connection between the piezoelectric element and the transponder chip. In this case, the transponder chip is preferably implemented as a packaged IC instead of a bare die.

For example, an area of the transponder or piezoelectric element may correspond to the area of the printed circuit board. A height of the printed circuit board is designed such that the overall height of the transponder is not excessively increased. In particular, the printed circuit board is designed to be as thin as possible. In total, this results in a low height of a maximum of approximately 3 mm.

The circuit board can have relief structures on a bottom side. In this case, a contact area between the circuit board and the piezoelectric element can be significantly reduced so that only a small percentage of the area of the circuit board is in contact with the piezoelectric element.

The printed circuit board allows additional electrical components, such as a matching network and/or sensors, to be connected to the piezoelectric element in a simple manner without the need for further connection means or process steps. This provides a particularly versatile and flexibly usable transponder.

According to one embodiment, the transponder chip is a near field communication (NFC) chip. The transponder chip preferably complies with the standards for use in the 13.56 MHz ISM frequency range (proximity or vicinity chip, also summarized under the term NFC chips). An NFC chip obtains its system clock from the reader via the carrier frequency, and can also operate in a different frequency, for example from 9-14 MHz. This allows optimal adaptation to the characteristics of the acoustic channel. Overall, this provides a particularly flexible acoustic transponder.

According to one embodiment, a height or layer thickness of the piezoelectric material is set in such a way that a thickness resonance, i.e. a break-in in sound attenuation, is formed in the range from 9 MHz to 14 MHz. In other words, a height of the piezoelectric material is selected such that the transponder can be optimally used in the frequency range from 9 MHz to 14 MHz. In this way, the acoustic channel through the object obtains a “low attenuation window” which can be used advantageously for energy and data transmission. The layer thickness or height of the piezoelectric material is preferably <300 μm, preferably ≤200 μm.

According to one embodiment, the acoustic transponder has at least two electrodes. The electrodes are formed at least on a bottom side (lower electrode) and on a top side (upper electrode) of the piezoelectric element. Preferably, electrically conductive material (electrode material) is also formed on at least one side surface of the piezoelectric element. This allows the electrode to be guided from the bottom side via the side surface to the top side of the piezoelectric element. Contacting of both electrodes from the top side is thus possible.

The electrodes or the conductive material preferably comprise silver, in particular a silver solder paste. Preferably, the electrodes or the conductive material are at least partially elastic. In particular, the electrodes have a greater elasticity than the connection elements of the transponder chip.

The elastic design can prevent damage to the electrodes during manufacture of the transponder, in particular during flip-chip mounting of the transponder chip on the piezoelectric element.

A shape of the conductive electrodes is further configured such that the connection elements (bumps and/or bonding wires) of the transponder chip properly contact the piezoelectric element (and, if applicable, a matching network, e.g. an inductor). Preferably, the electrodes are adapted in such a way that further possible components (e.g. an intermediate element and/or a printed circuit board) arranged between the transponder chip and the piezoelectric element can be contacted easily and effectively.

Preferably, the electrodes are structured. In particular, the electrode on the top side of the piezoelectric element (upper electrode) is structured. The upper electrode can be structured in the form of a layout to provide a plurality of parallel connection surfaces, for example for an inductor, the transponder chip and/or further components.

Structuring of the upper electrode can already be carried out before the process of poling the piezoelectric element. In this way, parts of the area of the piezoelectric element can be kept free of electrically excited thickness oscillation later in operation. Consequently, by selectively structuring the upper electrode, the piezoelectric element can be divided into areas that either exhibit more resonant thickness vibration, or remain unpolarized and therefore quiet/non-vibrating.

A (parallel) capacitance of the piezoelectric element can also be adjusted by the shape of the electrodes (and the dielectric properties of the piezoelectric material, for example PZT).

According to one embodiment, an electrical impedance between the piezoelectric element and the transponder chip is set by a design of the piezoelectric element and/or the electrodes.

The piezoelectric element represents a capacitor due to its opposing electrodes and the dielectricity of the piezoelectric material between them. For a given piezoelectric element, this results in a terminal impedance at a given frequency. This becomes lower the larger the capacitance. To avoid a matching network of discrete components, a well-matched connection impedance can be achieved, for example, by suitably dimensioning the electrodes. In particular, a material and/or the height of the piezoelectric element and/or a material and/or a size and/or a structuring of the electrodes are selected in such a way that the impedance is optimally set.

According to one embodiment, the acoustic transponder further comprises at least one element for electrical impedance matching. For example, the transponder may comprise an inductor. In this case, the inductor represents a discrete separate component for impedance matching (matching network). The inductor may be an SMD (surface mounted device) component. The inductor may have a wire wound design or a multilayer ceramic design. The inductor may be electrically connected to the piezoelectric element by reflow soldering. Alternatively, the inductor may be connected to the piezoelectric element by conductive bonding.

The inductor is used in parallel with the capacitance of the piezoelectric element. Preferably, the inductor is dimensioned in such a way that the imaginary part of the impedance at the operating frequency is (largely) compensated, as happens with resonant circuits. According to one embodiment, the inductor is formed as a first planar coil. In other words, the inductor may be formed as a planar element. For example, an area of the inductor corresponds to the area of the piezoelectric element. In this case, the transponder may have an additional layered structure. In particular, an insulating layer may be formed between the inductor and the electrode on the top side of the piezoelectric element. The insulating layer may comprise a ferrite layer.

A planar coil is used as a loop antenna in conventional NFC technology. The first planar coil acts as the emitter of an alternating H-field. Consequently, this setup, in which the transponder chip can be omitted, creates a transparent transducer between the alternating H-field and the acoustic wave.

The transducer can be glued on a flat smooth metal surface. In this case, the transducer can convert NFC communication from the alternating H-field in air to a material wave. A similar component bonded opposite to the metal surface would convert from the material wave to alternating H-field (passive repeater for NFC signals through metal).

The combination of a thickness-vibrating piezoelectric element and a loop antenna in superimposed layers means that the transponder is designed as a transparent, resonant transducer between an acoustic wave and an alternating H-field. The application preferably on metal surfaces is facilitated by the use of a ferrite layer, which at the same time has an electrically insulating effect. The layer for coupling the piezoelectric element to the metal surface, for example a thin epoxy resin adhesive layer, also plays its part in the transmission characteristics of the acoustic channel.

Material geometry normally oscillates in certain modes. A metal plate, for example, exhibits narrowband resonances at multiples of the acoustic wavelength in the material and strong damping in between. This appears as a resonant comb. However, the piezo element also exhibits resonances due to its geometry and material properties described above.

Due to the elastic material properties described above, especially of the adhesive layer, an acoustic transmission channel with a relatively flat passband can be formed by superimposing these modes. In this passband, the strong attenuations of the resonant comb are absent. Such a channel can be used for data transmission according to the NFC scheme. Such a flat passband may be at frequencies greater than 10 MHz, for example, in a range greater than 10.5 MHz. For example, the range is around 11 MHz.

The dependence of this channel on the temperature and on the thickness of a homogeneous metal material is very small, because the individual peaks and notches of the resonance comb in the well permeable communication window are not as distinct as outside this area.

The transparent resonant transducer may further comprise an inductively coupled second planar coil. The second planar coil is formed on a bottom side of the piezoelectric element. The second planar coil has a larger surface area than the first planar coil. The second planar coil may be disposed on a ferrite foil for magnetic insulation. Consequently, the ferrite foil is located between the lower electrode and the second planar coil.

The first planar coil can be expanded to a larger antenna in the usual format of ID cards (ID1 according to ISO/IEC7810 or antenna class 1-6 according to ISO/IEC14443) by coupling with the second planar coil. The effective area of the planar coil can thus be effectively adapted to common formats, for example to the ID-1 card format and to antenna sizes of the NFC interfaces. This provides a particularly adaptable and flexible transducer.

According to one embodiment, the acoustic transponder comprises at least one identification number and/or at least one sensor, preferably a MEMS (Micro Electromechanical System) sensor.

The identification number is used for secure authentication with an acoustic link. The miniaturization of the acoustic transponder can further be used for position determination, simultaneously with identification and/or authentication. In particular, the miniaturized design of the transponder can be optimally used to determine a relatively precise position of the transponder. This facilitates the reading of the transponder or the identification of the workpiece in which the transponder is embedded. This provides a particularly efficient acoustic transponder.

The sensor may be a temperature sensor, pressure sensor, humidity sensor, gas sensor, light sensor, pulse counter, microphone, and/or a sensor of a similar type.

In particular, MEMS sensors are inexpensive to manufacture in large numbers, have good electrical properties and signal-to-noise ratio, and have low power consumption. This can provide an efficient and versatile transponder.

According to one embodiment, the miniaturized acoustic transponder can be used as an input element in the function with secure authentication. Here, the authentication initially allows access to the input of information. The determined position allows, for example, to operate a display on metal. For this purpose, an input element/display can be applied (for example, glued) to a surface of the workpiece into which the transponder is inserted and/or to which the transponder is coupled. This provides a particularly flexible transponder.

According to one embodiment, the transponder has at least one protection element. The protection element is adapted and arranged to protect the acoustic transponder from external influences. The at least one protection element preferably comprises a potting compound (mold). The potting compound completely encapsulates a top side of the transponder. The potting compound can also enclose parts of the side surface of the transponder.

The potting compound may be transparent to allow the transponder to emit light. Alternatively, the potting compound may be opaque to prevent light from affecting the function of the transponder. The potting compound may further contain magnetizable particles. To prevent the potting compound from covering a large portion of the piezoelectric element's surface, structures/balls that are difficult to wet can be used as a bottom layer between the potting compound and the piezoelectric element. The above-mentioned printed circuit board between the transponder chip and the piezoelectric element can also prevent wetting of the piezoelectric element with the potting compound.

The at least one protection element may further comprise a border. The border extends along a perimeter of the transponder. The border forms a sort of collar around a side surface of the transponder. The border increases a height of the transponder. In other words, a height of the border is greater than a height of the transponder before the border is disposed.

A volume in an inner area of the border is filled with the potting compound. The border thus forms a reservoir or limited volume for the potting compound. Furthermore, the border protects the side surface of the transponder from external influences.

The at least one protection element may further comprise a membrane. The membrane is formed on a bottom side of the transponder. However, the membrane may additionally extend at least partially over the side surface of the transponder. The membrane protects the bottom side of the transponder from external influences. The membrane may comprise steel. The membrane may have a larger surface area than the piezoelectric element. A lower end of the border may rest on the membrane. Thus, the border and the membrane can form a kind of sleeve of the transponder.

The membrane can be magnetic. Furthermore, the border can also be magnetic. In an acoustic transmission system which has a magnetic counterpart on the primary side, the transponder and the counterpart can thus be aligned and/or fastened to each other.

According to one embodiment, the transponder further comprises an intermediate element (interposer). The interposer is formed between the piezoelectric element and the transponder chip.

The intermediate element may have a metallized surface for establishing an electrical connection with the piezoelectric element and/or the transponder chip and/or other components of the transponder, for example the inductor.

Preferably, the metallized surface of the intermediate element is at least partially structured. In particular, a bottom side of the intermediate element facing the piezoelectric element can have a structure for providing a plurality of parallel, electrical contacts and/or for minimizing a contact surface between the intermediate element and the piezoelectric element. This improves the electrical connection reliability.

For example, short cylindrical columns may protrude from the bottom side of the intermediate element. Alternatively, the bottom side may have a structure of the walls of honeycombs, i.e. polygons. In this way, it is possible for the intermediate element to mechanically contact only a small portion of the piezoelectric element's area (for example, 10% of the area), while the rest of the area is free to vibrate. The piezoelectric element is thus less influenced in thickness oscillation. Furthermore, the influence can also be specifically adjusted and utilized by suitable selection of the percentage of surface contact.

According to one embodiment, however, the intermediate element may also comprise a molded component. The molded component comprises plastic. The intermediate element is a 3D plastic molded component. The molded component has conductive tracks for electrical contacting. The conductive tracks may extend on an outer side of the intermediate element. Alternatively, or additionally, the intermediate element can have conductive tracks on the inside.

Preferably, electrical conductive tracks are formed on a surface of the molded component. In particular, the intermediate element is produced by a process in which electrical conductive tracks can be formed on the surface of a plastic molded component doped with approximately 4% metal particles by means of laser processing.

According to one embodiment, a material and/or a structure of the intermediate element are adapted for vibration decoupling or damping. Preferably, the intermediate element is designed to be elastic. Preferably, the intermediate element is designed so elastically that vibrations, in particular by the acoustic wave in the 13.56 MHz range are well absorbed. This can be achieved in the interaction with the relief shape and the material property. This provides a very flexible and well adjustable transponder.

According to one embodiment, the intermediate element is thermally insulating. Preferably, the intermediate element has a material with very good thermal insulation properties. This allows the temperature-sensitive electronics of the transponder to be effectively protected from higher temperatures occurring for short periods.

According to a further aspect, the use of a miniaturized transponder is described. The miniaturized transponder preferably corresponds to the transponder described above. All properties disclosed with respect to the transponder or the use are also disclosed correspondingly with respect to the respective other aspect and vice versa, even if the respective property is not explicitly mentioned in the context of the respective aspect. The transponder is used in an object, for example in a metal tool or a 3D printed object.

The transponder is completely embedded in the object. In particular, no surface defects of the object are visible due to the transponder. The transponder remains in the object during the lifetime of the object. In other words, there is no provision for removal of the transponder from the object. The transponder remains in the object for obtaining measurement data from an interior of the object and/or for identifying the object and/or for controlling the object.

Alternatively, the transponder is coupled to a surface of a metallic object, such as a metal plate or a metal tube. The surface may be an outer surface and/or an inner surface of the object. The transponder may be releasably or permanently coupled to the surface. For example, the transponder is coupled to the metal surface magnetically or by means of an adhesive. Preferably, the adhesive is elastic. The transponder is coupled to the surface of the object for identifying the object and/or for obtaining measurement data and/or for controlling the object. The transponder can also have connected sensors, for example MEMS sensors, for obtaining measurement data. For identification purposes, the transponder may further have an identification number. Preferably, the transponder can be used as an input element. For this purpose, a display may be attached to a surface of the object, via which a user can enter data.

According to a further aspect, an acoustic transmission system is described. The German patent application with the number 10 2020 108 905.8, the contents of which are incorporated by reference as part of this disclosure, describes a corresponding acoustic transmission system and a concept for using the acoustic wave to transmit information through the material metal of a tool or 3D printed component for the purpose of identification.

The acoustic transmission system has a primary side and a secondary side. On the primary side, the transmission system has a transmitting unit, a receiving unit (a so-called “reader”) and an electroacoustic transducer, for example a piezoelectric element.

The transmitting unit is designed and configured to provide a transmitting signal. The receiving unit is designed and configured to receive a receiving signal in response to the transmitting signal. The electroacoustic transducer is designed and configured to convert the transmitting signal into an acoustic signal and an acoustic signal into a receiving signal.

Furthermore, the acoustic transmission system has a miniaturized transponder on the secondary side. The miniaturized transponder has a transponder chip and an electroacoustic transducer (piezoelectric element).

The miniaturized transponder corresponds to the miniaturized transponder described above. In particular, the miniaturized transponder has all the features described in connection with the above transponder. The miniaturized transponder is adapted and designed to receive a receiving signal and transmit a transmitting signal. The transponder is designed and arranged to use the clock of the receiving unit as the system clock. The piezoelectric element of the miniaturized transponder of the secondary side can establish acoustic contact with the electroacoustic transducer of the primary side.

Furthermore, the acoustic transmission system has an acoustic coupling medium between the primary side and the secondary side. The coupling medium is permeable to acoustic signals. The coupling medium may comprise a gel or oil.

The acoustic transmission system uses the acoustic wave to transmit information for the purpose of identifying an object, for example a tool made of metal or a 3D printed part. This principle is essentially independent of the surface of the object to be identified.

For example, the surface can be completely closed and carry the acoustic tag for identification inside. Furthermore, it is possible to process the entire surface of the object and still maintain the identification. Alternatively, the transponder may be coupled to the surface of the object. To enable processing of the surface, the transponder may also be detachably coupled to the surface. This provides a reliable, efficient system for information transfer that is independent of further processing of the object to be identified.

Furthermore, as the acoustic transponder is particularly small (miniaturized) and simple, it can also be embedded in or coupled to small objects (tools or metal parts or metal plates or tubes) without substantially weakening the structure. This miniaturization is also an advantage, for example, over Loop antennas which are used in the 13.56 MHz range, for example, and cannot be efficiently made as small as the acoustic design allows. This provides a particularly flexible system for information transmission. Furthermore, the miniaturization of the transponder enables a very accurate position determination and thus a very efficient readout of the transponder.

According to one embodiment, the receiving unit is adapted and arranged to drive a plurality of piezoelectric elements, for example two, three, five or ten piezoelectric elements. This forms a larger area for detecting multiple acoustic transponders. This can be done either continuously, or time sequenced using a multiplexing method. A display for HMI (Human Machine Interface) input can also be set up in this way.

According to one embodiment, the receiving unit is adapted and arranged to drive a piezoelectric element that is larger than that of the miniaturized transponder. In this way the detection range can be increased and/or several acoustic transponders can be addressed.

According to a further aspect, a method for manufacturing a miniaturized transponder is described. Preferably, the method produces the transponder described above. Any features disclosed with respect to the transponder or the method are also disclosed correspondingly with respect to the respective other aspect, and vice versa, even if the respective feature is not explicitly mentioned in the context of the respective aspect. The method comprises the following steps:

A) Providing a plurality of transponder chips comprising a plurality of integrated circuits on a wafer. The transponder chips can each have at least one connection element, preferably two connection elements. The connection elements are preferably formed as bumps. The connection elements preferably comprise gold.

The transponder chips are preferably used as bare die of the miniaturized transponder. The transponder chips each have a maximum height of 170 μm.

B) Providing a plurality of piezoelectric elements. The piezoelectric elements are disc-shaped. Alternatively, the piezoelectric elements can also be rectangular. The piezoelectric elements have, for example, homogeneous PZT. The piezoelectric elements have a maximum height of 300 μm, preferably 200 μm. The respective piezoelectric element is an electroacoustic transducer. The respective piezoelectric element acts as a substrate of the miniaturized transponder.

In each case, an electrode is formed on a bottom side and a top side of the respective piezoelectric element. Preferably, electrode material is also located on at least one side surface of the piezoelectric element. The electrodes comprise a material with elastic properties, for example silver. In particular, the material of the electrodes is more elastic than the material of the connection elements.

C) Providing a connecting means, for example an adhesive. The connecting means preferably comprises an epoxy resin. The connecting means has elastic properties. In the case that a printed circuit board is provided between the piezoelectric element and the transponder chip, this step can also be omitted.

D) Electrical and mechanical connection of transponder chips and piezoelectric elements by means of the connecting means. In particular, the respective piezoelectric element and the respective transponder chip are connected to each other by means of flip-chip assembly. In the case where a printed circuit board is provided between the piezoelectric element and the transponder chip, this step may also be omitted. Instead, in this step the printed circuit board is connected to the piezoelectric element and the transponder chip, which is preferably designed here as a packaged chip.

Furthermore, a coating or surface passivation can be applied at this point. The surface passivation serves to protect against corrosion. Furthermore, the surface passivation can help to decouple a top side of the transponder from pressure and temperature.

E) Separation into individual components to produce a plurality of miniaturized transponders.

In an optional further step, before the transponder chip and piezoelectric element are connected, the intermediate element described above can be provided and arranged on the piezoelectric element. Subsequently, the transponder chip is connected to a top side of the intermediate element by means of a connecting means.

In the form of so-called wafer level packaging, the process enables parallel processing and testing of a large number of units and thus efficient and cost-effective provision of a large number of miniaturized transponders.

The disclosures comprises the following aspects, among others:

1. Acoustic transponder (1) for an acoustic transmission system comprising:
a transponder chip (2),
a piezoelectric element (4) for converting a carrier frequency into an electric voltage, wherein the transponder (1) has a miniaturized design.

2. Acoustic transponder (1) according to aspect 1,
wherein the transponder (1) has a height (h)<3 mm.

3. Acoustic transponder (1) according to aspect 1 or 2,
wherein the piezoelectric element (4) has a height≤300 μm.

4. Acoustic transponder (1) according to any one of the preceding aspects,
wherein the transponder (1) is adapted to be completely embedded in a workpiece.

5. Acoustic transponder (1) according to aspect 4,
wherein the workpiece is a metallic component and/or a 3D printed part.

6. Acoustic transponder (1) according to any one of the preceding aspects,
wherein the transponder chip (2) is applied to the piezoelectric element (4) by means of flip-chip technology.

7. Acoustic transponder (1) according to any one of the preceding aspects,
wherein the height of the piezoelectric material is adjusted such that a thickness resonance is formed in the range of 9 MHz to 14 MHz.

8. Acoustic transponder (1) according to any one of the preceding aspects,
further comprising at least two electrodes (5), wherein the electrodes (5) are formed at least on a bottom side (4b) and on a top side (4a) of the piezoelectric element (4), and wherein the electrodes (5) are formed at least partially elastically.

9. Acoustic transponder (1) according to any one of the preceding aspects or according to aspect 8,
wherein an electrical impedance between the piezoelectric element (4) and the transponder chip (2) is set by a design of the piezoelectric element (4) and/or the electrodes (5).

10. Acoustic transponder (1) according to any one of the preceding aspects,
further comprising at least one element for electrical impedance matching.

11. Acoustic transponder (1) according to aspect 10,
wherein the transponder (1) comprises an inductor for adjusting the impedance, and wherein the inductor is connected in parallel to a capacitance of the piezoelectric element (4).

12. Acoustic transponder (1) according to any one of the preceding aspects,
wherein the transponder chip (1) is an NFC chip.

13. Acoustic transponder (1) according to any one of the preceding aspects,
further comprising at least one MEMS sensor.

14. Acoustic transponder (1) according to any one of the preceding aspects,
further comprising an identification number for secure authentication.

15. Acoustic transponder (1) according to any one of the preceding aspects,
wherein the miniaturization of the acoustic transponder (1) can be used for position determination and at the same time with identification and/or authentication.

16. Acoustic transponder (1) according to any of the preceding aspects,
wherein the piezoelectric element (4) is made of lead-free material.

17. Use of a miniaturized acoustic transponder (1) in an object (8), wherein the transponder (1) is completely embedded in the object (8) and wherein the transponder (1) remains in the object (8) during the lifetime of the object (8) for obtaining measurement data from an interior of the object (8) and/or for identifying the object (8) and/or for controlling the object (8).

18. Use according to aspect 17,
wherein the miniaturized acoustic transponder (1) can be used as an input element in the function with secure authentication.

19. Acoustic transmission system comprising
A) on a primary side:
   a transmitting unit intended and adapted for providing a transmitting signal,
   a receiving unit intended and adapted to receive a receiving signal in response to the transmitting signal,
   an electroacoustic transducer intended and adapted for converting the transmitting signal into an acoustic signal and an acoustic signal into a receiving signal,
B) on a secondary side:
   a miniaturized transponder (1) according to any one of aspects 1 to 16, wherein the transponder (1) is intended and adapted to receive a receiving signal and transmit a transmitting signal,
C) an acoustic coupling medium between the primary side and the secondary side.

20. Acoustic transmission system according to aspect 19,
wherein the transponder (1) is adapted and arranged to use the clock of the receiving unit as system clock.

21. Acoustic transmission system according to aspect 19 or 20,
wherein the receiving unit is adapted to drive a plurality of piezoelectric elements (4) and/or to drive a piezoelectric element (4) which is larger than that of the transponder (1), and thereby to enlarge the detection range and/or to address a plurality of acoustic transponders (1).

22. Method for manufacturing a miniaturized transponder (1) for an acoustic transmission system comprising the following steps:
A) providing a plurality of transponder chips (2) comprising a plurality of integrated circuits on a wafer;
B) providing a plurality of piezoelectric elements (4), wherein an electrode (5) is formed on at least a bottom side (4b) and a top side (4a) of the respective piezoelectric element (4), respectively;
C) Providing a connecting means (6);
D) Electrical and mechanical connection of transponder chips (2) and piezoelectric elements (4) by means of the connecting means (6);
E) Separation into individual components to produce a plurality of miniaturized transponders (1).

23. Method according to aspect 22,
wherein the respective piezoelectric element (4) and the respective transponder chip (2) are connected to each other by means of flip-chip assembly.

24. Method according to aspect 22 or 23,
further comprising the step of;
application of a passivation, wherein the passivation is applied before separation into individual components.

The drawings described below are not to be understood as true to scale. Rather, individual dimensions may be enlarged, reduced or even distorted for better representation.

Elements that are similar to each other or that perform the same function are designated with the same reference signs.

It show:

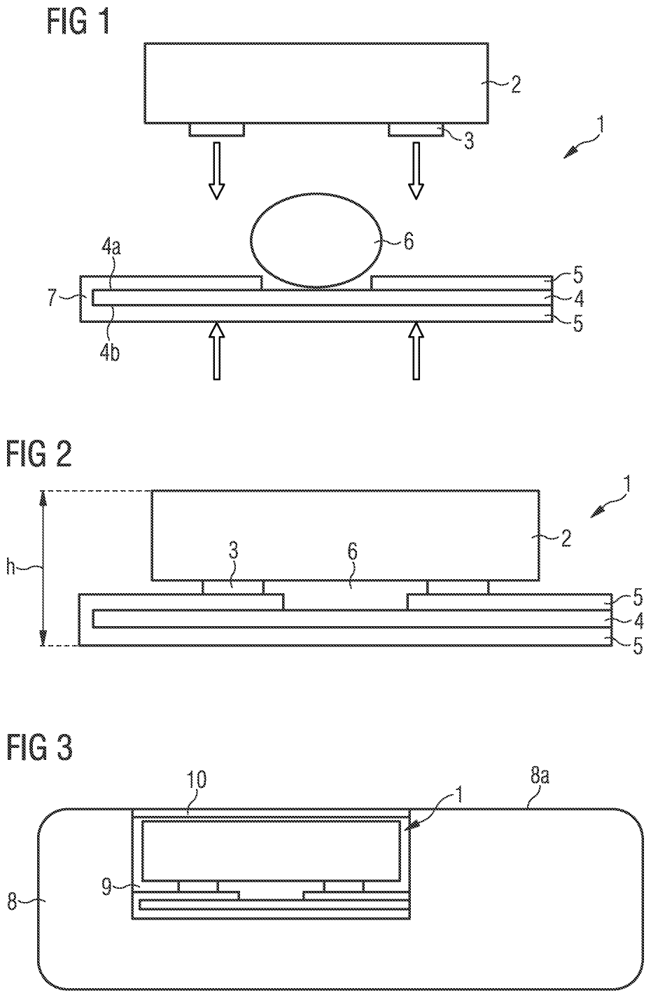

FIG. 1 a sectional view of an intermediate stage in the manufacture of a miniaturized transponder according to an embodiment,

FIG. 2 a sectional view of a miniaturized transponder according to an embodiment,

FIG. 3 a sectional view of a miniaturized transponder embedded in an object,

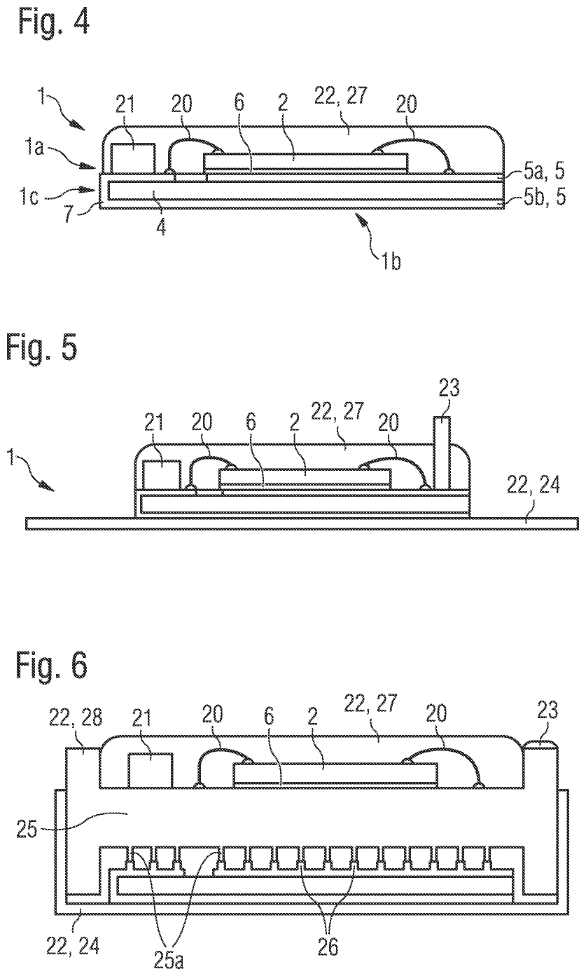

FIG. 4 a sectional view of a miniaturized transponder according to a further embodiment,

FIG. 5 a sectional view of a miniaturized transponder according to a further embodiment,

FIG. 6 a sectional view of a miniaturized transponder according to a further embodiment,

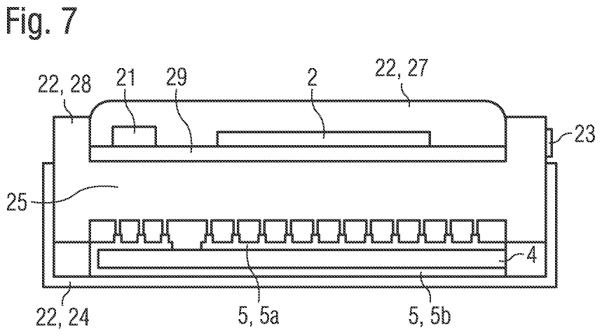

FIG. 7 a sectional view of a miniaturized transponder according to a further embodiment.

FIG. 2 shows an acoustic transponder 1, in short transponder 1, in miniaturized design. The transponder 1 is adapted to enable information transmission by means of an acoustic wave and to be integrated into an acoustic transmission system (not shown) for this purpose.

The transponder 1 serves to identify an object 8 (see FIG. 3). The object 8 can be, for example, a metallic component (such as a metal tool) or a 3D printed part. The transponder 1 can, for example, have an identification number and thus ensure secure authentication of the object 8.

The transponder 1 may further be used for controlling an object 8 (for example, a battery) and/or for measurements in an interior of an object 8. For the latter, the transponder 1 may comprise a sensor, for example a MEMS sensor (not explicitly shown).

The transponder 1 comprises a transponder chip 2. The transponder chip 2 has an integrated circuit. The transponder chip 2 serves as bare die of the transponder 1. The transponder chip 2 is an NFC chip and thus essentially supports a frequency of 13.56 MHz. An NFC transponder chip obtains its system clock from the reader via the carrier frequency, and can therefore also operate in a wider frequency range, for example from 9-14 MHz. The transponder chip 1 has a maximum height of 170 μm.

The transponder chip 2 has two connection elements 3. These are formed on a bottom side of the transponder chip 2. In this embodiment, the connection elements 3 are bumps. The connection elements 3 comprise a rigid material, preferably gold. The connection elements 3 serve to electrically connect the transponder chip 2 to a piezoelectric element 4.

The piezoelectric element 4 is serves to convert a carrier frequency as the signal waveform of an acoustic wave into the signal waveform of an electric voltage. It is an electroacoustic transducer. The piezoelectric element 4 may comprise PZT or a lead-free material and is disc-shaped.

The piezoelectric element 4 has a height of <300 μm, preferably ≤200 μm. In this context, the height of the piezoelectric element 4 is understood to be an extension of the piezoelectric element 4 perpendicular to a main extension direction of the transponder 1.

The piezoelectric element 4 serves as a circuit board of the transponder 1 and has electrodes 5. The electrodes 5 are formed at least on a bottom side 4b (see FIG. 1) and on a top side 4b of the piezoelectric element 4. The electrodes 5 may also extend over one or both side surfaces of the piezoelectric element 4 for electrical contacting of both electrodes from the top side 4a. Thus, it can be seen from FIG. 2 that electrically conductive material 7 (electrode material) surrounds a side surface of the piezoelectric element 4 to thus guide the lower electrode 5 to the top side 4a.

The electrodes 5 are structured. In particular, the electrode 5 on the bottom side 4b is formed over the entire surface. In contrast, the electrode 5 at the top side 4a covers only a partial area of the top side 4a of the piezoelectric element 4.

For the function of the transponder chip 2 it is crucial that the carrier frequency originating from a reader and converted into a voltage via the piezoelectric element 4 has the correct voltage amplitude. Due to the IC input structure, for example, a minimum voltage of 6 Vₚₚ is required. Furthermore, a certain minimum current is required, for example 0.5 mA. If higher voltages result, this is limited by a voltage limiter in the IC.

The piezoelectric element 4 represents a capacitor. As described above, the transponder chip 2 requires a certain voltage at the input, which requires a certain capacitance of the piezoelectric element 4. For a certain piezoelectric element 4, a connection impedance results at a certain frequency. This becomes lower the larger the capacitance. In order to avoid a matching network of discrete components (for example an inductor), a well-matching connection impedance can be achieved by suitable dimensioning and/or structuring of the electrodes 5 (see above) as well as the piezoelectric element 4.

Alternatively, the transponder 1 may also have an inductor for electrical impedance matching (not explicitly shown). The inductor is used in parallel with the capacitance of the piezoelectric element 4. A resonant circuit is formed with the inductor, thereby increasing the voltage. Preferably, the inductor is dimensioned to compensate for the imaginary part of the impedance at the operating frequency, as happens with resonant circuits.

The electrodes 5 are electrically and mechanically connected to the transponder chip 2 via a connecting means 6, for example an epoxy resin. The connecting means 6 is elastic in order to compensate for vibrations of the piezoelectric element 4 and to achieve an optimum connection of the piezoelectric element 4 to the transponder chip 2, as will be explained further below in connection with the description of the manufacturing process.

The transponder 1 has a miniaturized design. This means that a height h and/or a volume of the transponder 1 are designed to be very compact, in particular more compact than conventional transponders. The transponder 1 has a maximum height h<3 mm. The transponder 1 has a maximum area of 0.4 mm² to 4 mm². Thus, the transponder 1 can be partially or also completely embedded in the object 8, as can be seen in FIG. 3.

In the embodiment shown, the object 8 has a recess or blind hole 9 for this purpose, in which the transponder 1 is completely inserted. The recess 9 is closed by a cover layer 10. As a result, no detectable defects on a surface 8a of the object are perceptible. In particular, the surface 8a of the object 8 can be processed during its lifetime without affecting the function of the transponder 1.

In an alternative embodiment (not explicitly shown), the transponder 1 may also be adhered to a free surface or an indentation of the object 8. This assumes a cavity or free surface of the object 8. In this case, the transponder 1 is not fully integrated into an interior of the object 8.

In an alternative embodiment (not explicitly shown), the transponder 1 may be embedded in the object 8 using additive manufacturing (3D printing). In this case, the transponder 1 may be embedded in a starting material. Subsequently, another material can be produced over the starting material so that the transponder 1 is completely embedded in the finished object 8.

Due to the miniaturization of the transponder 1, it can be optimally used for position determination, simultaneously with identification or authentication of the object 8. The miniaturized acoustic transponder 1 can also be used as an input element. For this purpose, a display (not explicitly shown) may be applied, for example glued, to a surface of the object 8. In this context, the authentication initially allows access to input information, and the position allows the display on the object 8 to be operated.

As described above, the transponder 1 is integrated into an acoustic transmission system (not explicitly shown).

The acoustic transmission system has a primary side and a secondary side. On the primary side, the transmission system has a transmitting unit, a receiving unit (reader) and an electroacoustic transducer.

The transponder 1 is located on the secondary side of the transmission system and is fully integrated in the object 8, for example. It receives a receiving signal output by the transmitting unit and transmits a transmitting signal 8. Thereby, an acoustic wave is used to transmit information, for example for the purpose of identifying the object 8.

For example, if the transponder 1 is integrated into the shank of a drill, then when the workpiece is not in use, the shank is deposited in the production machine in such a way that it is can be automatically clamped back into the drill chuck. This counterpart, in which the drill remains, can be equipped with a corresponding acoustic reader, and may also contain an acoustic coupling medium (gel, also oil). The reader will have a larger piezo element to ensure a good connection at all times. Thus, the ID number of the deposited tools can be read out and their service life can be updated in the system.

It is also possible to house the acoustic reader in the chuck of the machine tool that holds the tool, or the shank of the tool. In this way, measurement data from the tool could be recorded and incorporated into the machining process.

It is also possible to identify a 3D printed part when it is held by a gripper for assembly with other parts. The gripper in this case would contain the acoustic reader, and the process of gripping allows the mechanical coupling to the workpiece, which is necessary to form an acoustic channel for the acoustic wave.

In the following, a method for manufacturing a miniaturized transponder 1, preferably the transponder 1 described above, is described. The method comprises the following steps:

In a first step A), a plurality of transponder chips 1 is provided. The transponder chips 1 are NFC chips and preferably operate in a frequency range of 9 to 14 MHz. The transponder chips 1 have a plurality of integrated circuits on a wafer.

The transponder chips 1 each have two connection elements 3. The connection elements 3 preferably comprise gold. The transponder chips 1 each have a maximum height of 170 μm.

In a next step B), a plurality of piezoelectric elements 4 is provided as signal transducers. The piezoelectric elements 4 are disc-shaped and comprise, for example, PZT. The piezoelectric elements 4 have a maximum height of 300 μm, preferably 200 μm.

Electrically conductive material 7 (electrodes 5) is formed on the bottom side 4b and the top side 4a and preferably on at least one side surface of the piezoelectric element 4 for electrical contacting of the respective piezoelectric element 4. The electrodes 5 comprise an elastic material, preferably silver. The elasticity of the electrically conductive material 7 ensures that the electrodes 5 do not break under pressure when the piezoelectric element 4 is connected to the transponder chip 2.

In a further step C), a connecting means, for example an adhesive, is provided. The connecting means preferably comprises an epoxy resin and is elastic. The elasticity of the connecting means 6 is important to compensate for the vibrations (thickness oscillations) of the piezoelectric element 4.

In a next step D), the electrical and mechanical connection of transponder chips 2 and piezoelectric elements 4 is carried out with the aid of the connecting means 6 (see in particular FIG. 1). In particular, the respective piezoelectric element 4 and the respective transponder chip 2 are connected to each other by means of direct chip attach/flip chip assembly.

For this purpose, the wafer with the transponder chips 2 is rotated so that the connection elements 3 make electrical contact with corresponding surfaces of the electrodes 5 of the respective piezoelectric element 4. The connecting means 6 is intended to provide a permanent mechanical connection in this process. The connecting means 6 contracts slightly during curing, thus pressing the connection elements 3 of the transponder chip 2 against corresponding contact surfaces of the electrodes 5. At the same time, the connecting means 6 should remain somewhat elastic in order to exert forces to the correct extent on the transponder chip 2 and the piezoelectric element 4. For this reason, the electrodes 5 must also be somewhat elastic.

In a further step, a coating or surface passivation can be applied. The surface passivation serves to protect against corrosion. Furthermore, the surface passivation can help to decouple a top side of the transponder 1 from pressure and temperature, which occur for a short time during additive manufacturing.

In a final step E), the separation into individual components is carried out in order to produce a plurality of miniaturized transponders 1.

FIG. 4 shows another embodiment of a miniaturized acoustic transponder 1. The acoustic transponder 1 according to FIG. 4 is (like the transponder 1 according to FIGS. 5 to 7) adapted to establish a communication channel for transmitting information and energy by means of a material wave, in particular through a metal surface.

The acoustic transponder 1 is characterized by the fact that information processing, for example in the sense of receiving a command and a response with an identification number, takes place entirely in a silicon chip (transponder chip 2) and is not generated, for example, by reflectors for acoustic surface waves (SAW transponder).

The transponder 1 comprises the following components, as already described in connection with FIGS. 1 to 3:
a transponder chip 2 (preferably made of silicon as bare die),
a piezoelectric element 4 operating as a thickness transducer (preferred diameter to thickness ratio<1:20) having a top side 4a and a bottom side 4b, and
electrodes 5 (in particular, an upper electrode 5a and a lower electrode 5b).

The features and functions described further above with respect to these components also apply to the embodiments described below for the acoustic transponder 1.

The transponder chip 2 is mechanically fixed—at its non-functional rear side—to the piezoelectric element 4 by a connecting means 6, for example an adhesive. Electrical connections (connectors 20) can be created between the transponder chip 2 and the piezoelectric element 4 by bonding. In the simplest case, for a pure ID transponder (which responds to a request from the reader with its unique identity number), two connections are required, which are guided by connection surfaces of the two electrodes 5, 5a, 5b of the piezoelectric element 4.

The transponder 1 is particularly suitable for coupling to a surface of a metallic object 8, for example a metal tube. Preferably, a material of the object 8 (e.g. the metal plate) is homogeneous, and there is one side for coupling in and one side for coupling out to the piezoelectric element 4. This may be realized by a thin adhesive layer (between the metal plate and the piezoelectric element 4), as will be described further below. The acoustic wave of the transponder 1 is directed into the material (e.g. metal plate) essentially normal to the surface.

In one embodiment, the metallized top side (upper electrode 5a) of the piezoelectric element 4 is structured (see, for example, structure 26 in FIGS. 6 and 7). The upper electrode 5a may be patterned in the form of a layout to provide connection pads for an inductor 21, which will be described in more detail below. By patterning the upper electrode 5a, the inductor 21 can be assembled by the method of reflow soldering or, alternatively, by conductive bonding.

Structuring of the upper electrode 5a can already be done before the process of poling the piezoelectric element 4, for the purpose of keeping parts of the area of the piezoelectric element 4 free from electrically excited thickness vibration later in operation. In other words, by selectively patterning the upper electrode 5a, the piezoelectric element 4 can be divided into areas that either exhibit more resonant thickness vibration, or remain unpolarized and therefore quiet/non-vibrating.

The transponder 1 further comprises a protection element 22. In this embodiment, the protection element 22 comprises a potting compound 27. The potting compound 27 is formed on a top side 1a of the transponder (thus corresponding to the rear side, i.e. the side facing away from the object 8, of the transponder 1). The potting compound 27 completely encapsulates the top side 1a and at least parts of a side surface 1b of the transponder 1. The potting compound 27 protects the transponder 1 from external influences.

The potting compound 27 may be transparent to allow the acoustic transponder to emit light into the interior, for example, of a metal tube. The potting compound 27 may be opaque to prevent light from affecting the operation of the transponder 1. The potting compound 27 may contain magnetizable particles.

To prevent the potting compound 27 from covering a large portion of the area of the piezoelectric element 4 on the inside, structures/balls that are difficult to wet can be used as a bottom layer.

Furthermore, it is possible to provide a thin printed circuit board or circuit board between the piezoelectric element 4 and the potting compound 27 (not explicitly shown). This circuit board may have relief structures on its bottom side so that only a small percentage of the area of the circuit board is in contact with the piezoelectric element 4.

The transponder 1 further comprises the inductor 21 mentioned above. The inductor 21 is electrically connected in parallel to the two electrodes 5, 5a, 5b. In this embodiment, the inductor 21 is formed as a discrete electrical component. For example, the inductor 21 is formed in an SMD format. Here, wire-wound designs, or ceramic multilayer designs are possible.

The transponder 1 can, for example, have the shape of a flat cylinder. In the application, the transponder 1 is acoustically bonded to a flat, plane and smooth metal surface, for example by using a coupling element with a certain layer thickness. The coupling element may comprise an adhesive, for example an epoxy resin.

In another embodiment (see FIG. 5), the transponder 1 may further comprise an interface 23 for external connection of the transponder 1. In this embodiment, the interface 23 is electrically and mechanically connected to the upper electrode 5a and protrudes from the top side of the transponder 1 for electrical connection to an external electronic component.

The transponder 1 may further comprise a further protection element 22, for example a protective layer or membrane 24 (FIG. 5). The membrane 24 is formed on a bottom side 1b of the transponder 1. Preferably, the membrane 24 is glued to the bottom side 4b of the piezoelectric element or to the lower electrode 5b. The membrane 24 may comprise steel, for example a steel sheet. The membrane 24 may be magnetic.

To couple the transponder 1 to the metal surface of the object 8, the membrane 24 can be glued to the surface of the metal. Magnetic bonding to the metal surface of the object 8, to form a releasable connection, is also conceivable. An area of the membrane 24 is larger than an area of the piezoelectric element 4 or the transponder 1, in order to ensure an optimal connection to the metal surface.

In order to achieve good acoustic contact between the membrane 24 or the piezoelectric element 4, and the acoustic channel (surface of the metallic object 8), a coating of the surface of the membrane 24 or piezoelectric element 4 with a thin elastic layer can be provided (not explicitly shown). This has the purpose of widely filling the voids formed due to surface roughness of the opposing metal surfaces with a medium that has significantly higher acoustic impedance than air. The efficiency of the acoustic coupling can thus be significantly increased.

Further, in order to make a housing for the acoustic transponder 1, a protection element 22 in the form of a border along the circumference of the transponder 1 can be provided (not explicitly shown in FIG. 5, see for example border 28 in FIG. 6). In other words, a border is formed along the side surface 1c of the transponder 1. In this case, a height of the border 28 is greater than a height of the components in an inner region of the transponder 1. The volume inside the border 28 can then be filled with the potting compound 27 so that the components inside are protected. For example, the border 28 may be placed on the membrane 24 described above to provide a transponder 1 that is protected from all sides (top side 1a, side surface 1c, bottom side 1b).

In order to achieve a holding force of the acoustic transponder 1 on the metallic surface, the border 28 may comprise a magnetic material. The border 28 may be in the form of a ring magnet.

As mentioned further above, the membrane 24 may also be correspondingly magnetic or magnetized.

For example, steel is a suitable material for the border 28/membrane 24 to prevent the transponder 1 from emitting contaminating gases. Many applications require for sensors in gas and pressure vessels, which are made of stainless steel, that only stainless-steel surfaces may be used inside, and a to exclude contamination of the gases. Thus, it would also be possible to design membrane 24 and border 28 as one sleeve with a shot surface.

If the counterpart of the acoustic transmission system on the outside of the tube is also suitably magnetic, a holding force and at the same time an alignment of the two acoustic counterparts (on the primary and secondary sides) are given.

If the transponder 1 is to be coupled to a curved surface, for example mounted inside a pipe, the length of the vibrating piezoelectric element 4 in relation to a pipe inner diameter is critical to minimize losses due to destructive interference. Thus, in this case, the supporting surface of the acoustic transponder 1 may be essentially that of a rectangle with its short side lying along the diameter of the pipe and its long side lying along the length of the pipe (straight piece).

A further embodiment provides for the inductor 21 to be designed in the form of a layout as a planar coil (design as a transparent passive repeater without transponder chip 2, not explicitly shown). In order to be able to keep a large-area electrode shape for the piezoelectric element 4 independently of the planar coil, a layer sequence of piezoelectric element 4—upper electrode 5, 5a—insulating and/or magnetically insulating layer (for example a ferrite layer)—planar coil can be used.

Since the planar coil also acts as an emitter of an alternating H-field, and is used in conventional NFC technology as a loop antenna, this setup (even without transponder chip 2) creates a transparent transducer between the alternating H-field and the acoustic wave. This transducer, glued to a flat smooth metal surface, thus converts NFC communication from the H alternating field in air to a material wave. A similar transducer glued on the opposite side of the metal surface would correspondingly convert from the material wave to the alternating H-field. Thus, a transparent passage/transparent, passive repeater for NFC signals through metal can be achieved.

The transparent repeater design can be suitable (due to the characteristics of the channel) for the NFC transmission standard in the 13.56 MHz frequency range, supporting the ISO/IEC14443 and ISO/IEC15693 protocols. The method of load modulation with subcarrier frequency used in these two standards can also be applied, since an electrical load changes the elastic properties of a piezoelectric element 4 and thus the usual modulation (combination of phase and amplitude modulation) can be detected by the reader in the signal reflected at the transponder side.

Moreover, the design may be such that the region of the acoustic wave below the piezoelectric element 4 perpendicular to a surface into the material has a small area.

Likewise, the transparent repeater may have more than one inductor 21 (not explicitly shown). For example, the repeater may have two inductors designed as planar coils. A first planar coil is formed above the piezoelectric element 4 (i.e., above the top side 4a of the piezoelectric element). The first planar coil has a small area (e.g. 5 mm in diameter). A second planar coil is formed below the piezoelectric element 4. An area of the second planar coil is larger than an area of the first planar coil. The second planar coil is inductively coupled to the first planar coil. The second planar coil is arranged on a ferrite foil for magnetic insulation, for example.

The first planar coil can be expanded to a larger antenna in the usual format of ID cards (ID1 according to ISO/IEC7810 or antenna class 1-6 according to ISO/IEC14443) by coupling with the second or secondary planar coil.

The larger area second planar coil (secondary antenna) may be designed as a thin “patch” on the surface of the object 8, particularly the metal. The second planar coil may provide a separate resonant circuit close to 13.56 MHz by connecting the secondary coil to a suitable capacitance. A second element (“patch” or secondary coil) is thus connected to the first planar coil by inductive coupling (two coils are spatially close to each other). Practically, the “patch” can comprise a hole the size of the first planar coil which facilitates the coupling in one plane during assembly.

FIG. 6 shows another embodiment of an acoustic transponder 1. The transponder 1 comprises a transponder chip 2, a piezoelectric element 4, electrodes 5, 5a, 5b, an inductor 21 and connectors With respect to the characteristics and functions of these components, reference is made to the above explanations.

The transponder 1 according to FIG. 6 additionally comprises an intermediate element 25. The intermediate element 25 is arranged between the transponder chip 2 and the piezoelectric element 4. The intermediate element 25 can comprise a printed circuit board (PCB). The transponder chip 2 is arranged and fixed on a top side of the intermediate element 25, for example via a connecting means 6, e.g., an adhesive.

By means of the intermediate element 25, a contact surface of the transponder chip 2 and/or the potting compound 27 on the top side 4a of the piezoelectric element 4 can be reduced. In other words, by means of the intermediate element 25, the transponder chip 2 and/or the potting compound 27 rest to a lesser extent on the top side 4a of the piezoelectric element 4 or on the upper electrode 5a. A quality of the natural resonance in the thickness oscillation mode of the piezoelectric element 4 is reduced the more full-surface the support is. However, this is disadvantageous for the efficiency of the conversion between mechanical and electrical amplitude.

The intermediate element 25 may be structured. In particular, a bottom side of the intermediate element 25, i.e., the surface facing the piezoelectric element 4, may have a structure 25a. For example, the intermediate element 25 may have short cylindrical columns protruding from the flat surface (bottom side of the intermediate element 25)). Alternatively, a structure of honeycomb walls, i.e., polygons, is possible. In this way, it is possible to mechanically contact only a small percentage of the surface of the piezoelectric element 4 (e.g., 10%), while the rest of the surface of the piezoelectric element 4 is free to vibrate. Thus, the piezoelectric element 4 is less influenced in thickness oscillation. Furthermore, it is also possible to selectively adjust and utilize the influence by suitable selection of the percentage of surface contact.

In addition to the mechanical connection, there must also be an electrical connection between the two electrodes 5a, 5b of the poled piezoelectric element 4 and the intermediate element 25. The same applies to the electrical connection to the connectors 20 and thus to the transponder chip 2 on the top side of the intermediate element 25.

One possibility for this is to provide a metallized surface with a certain structure for the intermediate element 25. For example, it is possible to sputter the structure and subdivide it by means of a mask in order to create corresponding parallel contact surfaces. The metallized intermediate element 25 can then be mechanically and electrically connected to the likewise metallized piezoelectric element 4, e.g., by reflow soldering.

Alternatively, a molded component of so-called 3D electronics can be used, i.e., a non-conductive plastic molded component that can have conductive tracks and even internal connections by means of laser treatment and further processes.

The intermediate element 25 can be of elastic design. In particular, the intermediate element 25 can have vibration-damping properties and thus—in addition to a correct layout as a support surface for components and/or transponder chip 2—also effect a decoupling or reduction of vibrations. Preferably, the intermediate element 25 is adapted in such a way that vibrations are well absorbed, in particular by the acoustic wave in the 13.56 MHz range. This can be achieved in the interaction of the relief shape and the material property can be achieved.

The intermediate element 25 may alternatively or additionally have thermal insulating properties. It can thus help to protect the temperature-sensitive transponder chip 2 from short hot phases in certain applications by means of a large thermal time constant.

Furthermore, a layout for assembling a circuit can exist on the intermediate element 25. The transponder chip 2 and the matching network (inductor 21) can be assembled there. In particular, sensors can also be connected to an electrical interface of the transponder chip 2 on a layout on the intermediate element 25, or another chip with analog-to-digital converter function. It is also possible to assemble embodiments of electrical contacts (e.g. pogo pins, flat contact surfaces which can also be arranged in a ring shape, or the like), which can later protrude from the package/potting compound 27 and be electrically contacted. It is thus possible, for example, to connect an analog pressure sensor in the form of a resistive bridge to the functional subassembly described here.

Furthermore, in order to reduce the overall height of the transponder 1, it is possible to equip the inductor 21 directly on the piezoelectric element 4, and the intermediate element 25 on a remaining surface of the piezoelectric element 4 (not explicitly shown).

As already described in connection with FIGS. 4 and 5, the transponder 1 may further comprise a protection element 22 in the form of a potting compound 27. The potting compound 27 completely encapsulates the top side 1a of the transponder 1. In this embodiment, the protection element 22 further comprises a border 28 as described above. In this regard, the border 28 into which the potting compound 27 is at least partially filled may be integrally formed with the intermediate element 25 or may be provided as a separate component. If the border 28 is formed integrally with the intermediate element 25, the intermediate element has a circumferential elevation (collar) in an outer region which functions as the border 28 (see FIG. 6).

The protection element 22 further comprises a membrane 24, as described above, which protects the bottom side of the transponder 1 from external influences. In this embodiment, the membrane 24 also extends partially over the side surface 1b of the transponder 1 or the intermediate element 25. The border 28 may rest on the membrane 24 (not explicitly shown).

Furthermore, the transponder 1 may also include an interface 23 for external connection of the transponder 1. In this embodiment, the interface 23 is formed at the border 28 for enabling a connection to an external component.

FIG. 7 shows another embodiment of a miniaturized acoustic transponder 1. The transponder 1 comprises a transponder chip 2, a piezoelectric element 4, electrodes 5, 5a, 5b, an inductor 21, a protection element 22 (membrane 24, potting compound 27, border 28) and an intermediate element 25.

In contrast to the transponder chip 2 according to the above embodiments, the transponder chip 2 according to FIG. 7 is not designed as a bare die, but as a packaged IC. With respect to all other features and functions of the listed common components, reference is made to the above explanations.

In this embodiment, a printed circuit board 29 (PCB) with conductive tracks is arranged between the transponder chip 2 and the intermediate element 25. The PCB 29 provides an electrical connection between the electrodes 5, a, 5b and the transponder chip 2 or the inductor 21. In this embodiment, the connectors 20 (wire bonds) described above can be omitted.

The description of the objects disclosed herein is not limited to the individual specific embodiments. Rather, the features of the individual embodiments can be combined with each other as desired—as far as technically reasonable.

### LIST OF REFERENCE SIGNS

1 Transponder
1a Top side of the transponder
1b Bottom side of the transponder
1c Side surface of the transponder
2 Transponder chip
3 Connection element
4 Piezoelectric element
4a Top side
4b Bottom side
5 Electrode
5a Upper electrode
5b Lower electrode
6 Connecting means
7 Conductive material/electrode material
8 Object
8a Surface of the object
9 Recess
10 Cover layer
H Height of the transponder
20 Connector
21 Inductor
22 Protection element
23 Interface
24 Membrane
25 Intermediate element
25a Structure of the intermediate element
26 Structure of the electrode
27 Potting compound
28 Border
29 Circuit board

1. An acoustic transponder for an acoustic transmission system comprising:
a transponder chip,
a piezoelectric element for converting a carrier frequency into an electric voltage, wherein the transponder has a miniaturized design.

2. The acoustic transponder according to claim 1, wherein the transponder has a height<3 mm and/or wherein the transponder has a diameter<5 mm.

3. The acoustic transponder according to claim 1, wherein the piezoelectric element has a height≤300 μm.

4. The acoustic transponder according to claim 1, wherein the transponder is configured to be completely embedded in a workpiece or wherein the transponder is configured to be acoustically bonded to a surface of a workpiece.

5. The acoustic transponder according to claim 4, wherein the workpiece is a metallic component and/or a 3D printed part.

6. The acoustic transponder according to claim 1, wherein the transponder chip is applied to the piezoelectric element by flip-chip technology.

7. The acoustic transponder according to claim 1, wherein the height of the piezoelectric material is adjusted such that a thickness resonance is formed in the range of 9 MHz to 14 MHz.

8. The acoustic transponder according to claim 1, further comprising at least two electrodes, the electrodes being formed at least on a bottom side and on a top side of the piezoelectric element.

9. The acoustic transponder according to claim 8, wherein the electrodes are at least partially elastic.

10. The acoustic transponder according to claim 8, wherein the electrode on the top side of the piezoelectric element is formed in a structured manner.

11. The acoustic transponder according to claim 1, wherein an electrical impedance between the piezoelectric element and the transponder chip is set by a design of the piezoelectric element and/or the electrodes.

12. The acoustic transponder according to claim 1, further comprising at least one element for electrical impedance matching.

13. The acoustic transponder according to claim 12, wherein the transponder comprises an inductor for adjusting the impedance, and wherein the inductor is connected in parallel to a capacitance of the piezoelectric element.

14. The acoustic transponder according to claim 13, wherein the inductor is formed as an SMD component and wherein the inductor is electrically connected to the piezoelectric element by reflow soldering or by conductive bonding.

15. The acoustic transponder according to claim 1, wherein the transponder chip is an NFC chip.

16. The acoustic transponder according to claim 1, further comprising at least one MEMS sensor.

17. The acoustic transponder according to claim 1, further comprising an identification number for secure authentication.

18. The acoustic transponder according to claim 1, wherein the miniaturization of the acoustic transponder can be used for position determination and at the same time with identification and/or authentication.

19. The acoustic transponder according to claim 1, wherein the piezoelectric element is made of lead-free material.

20. The acoustic transponder according to claim 1, further comprising at least one protection element adapted to protect the acoustic transponder from external influences.

21. The acoustic transponder according to claim 20, wherein the at least one protection element comprises a potting compound, and wherein the potting compound completely encapsulates a top side of the transponder.

22. The acoustic transponder according to claim 20, wherein the at least one protection element comprises a border along a perimeter of the transponder.

23. The acoustic transponder according to claim 22, wherein a volume in an inner region of the border is filled with a potting compound.

24. The acoustic transponder according to claim 20, wherein the at least one protection element comprises a membrane on a bottom side of the transponder, and wherein the membrane comprises steel.

25. The acoustic transponder according to claim 22, wherein the border is magnetic and/or wherein the membrane is magnetic.

26. The acoustic transponder according to claim 1, further comprising an intermediate element, the intermediate element being formed between the piezoelectric element and the transponder chip.

27. The acoustic transponder according to claim 26, wherein the intermediate element has a metallized surface for establishing an electrical connection with the piezoelectric element and/or the transponder chip.

28. The acoustic transponder according to claim 27, wherein the metallized surface of the intermediate element is at least partially structured.

29. The acoustic transponder according to claim 26, wherein a bottom side of the intermediate element facing the piezoelectric element has a structure for providing a plurality of parallel electrical contacts and/or for minimizing a contact surface between the intermediate element and the piezoelectric element.

30. The acoustic transponder according to claim 26, wherein the intermediate element comprises a molded component and wherein the molded component comprises conductive tracks.

31. The acoustic transponder according to claim 26, wherein a material and/or structure of the intermediate element is formed for vibration decoupling or damping.

32. The acoustic transponder according to claim 26, wherein the intermediate element is adapted to be thermally insulating.

33. The acoustic transponder according to claim 1, wherein a printed circuit board is arranged between the transponder chip and the piezoelectric element for electrical connection between the transponder chip and the piezoelectric element.

34. A use of a miniaturized acoustic transponder in an object, wherein the transponder is completely embedded in the object and wherein the transponder remains in the object during the lifetime of the object for obtaining measurement data from an interior of the object and/or for identifying the object and/or for controlling the object or
use of a miniaturized acoustic transponder on a surface of a metallic object, wherein the transponder is coupled to the surface of the object for identifying the object and/or for obtaining measurement data and/or for controlling the object.

35. The use according to claim 34, wherein the miniaturized acoustic transponder can be used as an input element in the function with secure authentication.

36. The acoustic transmission system comprising
A) on a primary side:
a transmitting unit intended and adapted for providing a transmitting signal,
a receiving unit intended and adapted to receive a receiving signal in response to the transmitting signal,
an electroacoustic transducer intended and adapted for converting the transmitting signal into an acoustic signal and an acoustic signal into a receiving signal,
B) on a secondary side:
a miniaturized transponder according to claim 1, wherein the transponder is intended and adapted to receive a receiving signal and transmit a transmitting signal,
C) an acoustic coupling medium between the primary side and the secondary side.

37. The acoustic transmission system according to claim 36, wherein the transponder is adapted and arranged to use the clock of the receiving unit as system clock.

38. The acoustic transmission system according to claim 36, wherein the receiving unit is adapted to drive a plurality of piezoelectric elements and/or to drive a piezoelectric element which is larger than that of the transponder, and thereby to enlarge the detection range and/or to address a plurality of acoustic transponders.

39. A method for manufacturing a miniaturized transponder for an acoustic transmission system comprising the following steps of:
A) providing a plurality of transponder chips comprising a plurality of integrated circuits on a wafer;
B) providing a plurality of piezoelectric elements, wherein one respective electrode is formed on at least a bottom side and a top side of the respective piezoelectric element;
C) providing a connecting means;
D) electrical and mechanical connection of transponder chips and piezoelectric elements by means of the connecting means;
E) separation into individual components for producing a plurality of miniaturized transponders.

40. The method according to claim 39, wherein the respective piezoelectric element and the respective transponder chip are connected to each other by flip-chip assembly.

41. The method according to claim 39, further comprising the step of:
application of a passivation, wherein the passivation is applied before separation into individual components.
